(19) United States
(12) Patent Application Publication
(10) Pub. No.: US 2025/0021234 A1
(43) Pub. Date: Jan. 16, 2025

(54) REDUCING TIME TO PROGRAM DURING ASYNCHRONOUS POWER LOSS HANDLING FOR A MEMORY SUB-SYSTEM

(71) Applicant: Micron Technology, Inc., Boise, ID (US)

(72) Inventors: Scott Anthony Stoller, Boise, ID (US); Brent C. Byron, Boise, ID (US); Sampath K. Ratnam, San Jose, CA (US); David Scott Ebsen, Minnetonka, MN (US)

(21) Appl. No.: 18/768,815

(22) Filed: Jul. 10, 2024

Related U.S. Application Data
(60) Provisional application No. 63/526,776, filed on Jul. 14, 2023.

(51) Int. Cl. G06F 3/06

(52) U.S. Cl. CPC G06F 3/0613; G06F 3/0659; G06F 3/0679

(57) ABSTRACT

In-flight host data is programmed to one or more single-level cell (SLC) caches of a memory device using the single phase program operation during an asynchronous power loss (APL) event responsive to one or more parameters of a single-phase program operation being updated.

### RELATED APPLICATIONS

This application claims the benefit of U.S. Provisional Patent Application No. 63/526,776, filed Jul. 14, 2023, which is incorporated by reference herein.

### TECHNICAL FIELD

Embodiments of the disclosure relate generally to memory sub-systems, and more specifically, relate to reducing time to program during asynchronous power loss handling for a memory sub-system.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates an example computing system that includes a memory sub-system in accordance with some embodiments of the present disclosure.

FIG. 2 is a block diagram of a memory device in communication with a memory sub-system controller of a memory sub-system, according to an embodiment.

FIG. 3A is a schematic illustration of a set of memory cells as arranged in a memory device.

FIG. 3B is a schematic illustration of the dependence of the source-drain current on the control gate voltage for two memory cells.

FIG. 3C is a schematic illustration of an example distribution of threshold control gate voltages for a memory cell.

FIG. 4 is a flow diagram of an example method to reduce time to program during asynchronous power loss handling for a memory sub-system in accordance with some embodiments of the present disclosure.

FIG. 5 is a block diagram of an example computer system in which embodiments of the present disclosure may operate.

### DETAILED DESCRIPTION

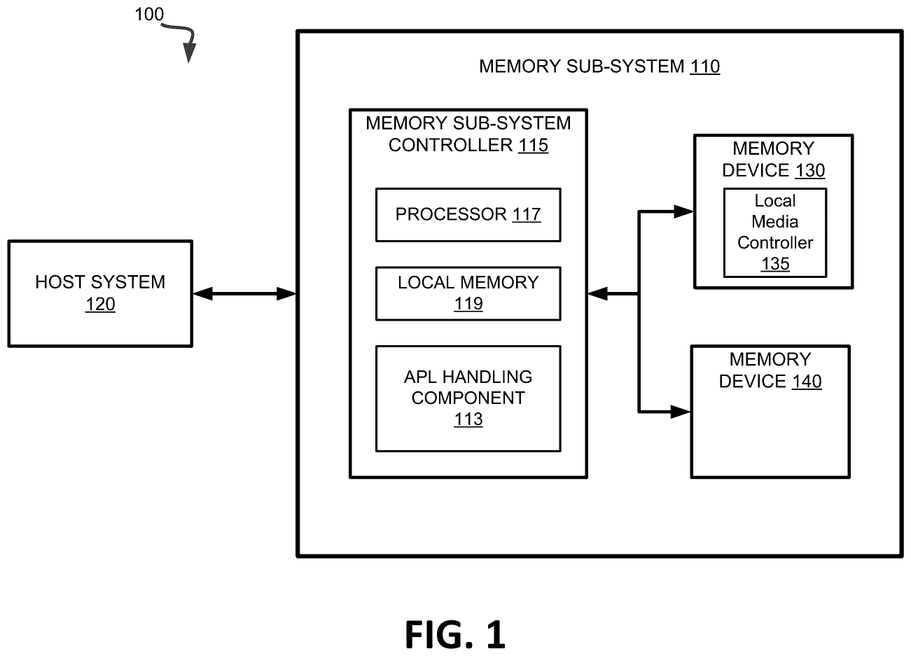

Aspects of the present disclosure are directed to reducing time to program during asynchronous power loss handling for a memory sub-system. A memory sub-system can be a storage device, a memory module, or a combination of a storage device and memory module. Examples of storage devices and memory modules are described below in conjunction with FIG. 1. In general, a host system can utilize a memory sub-system that includes one or more components, such as memory devices that store data. The host system can provide data to be stored at the memory sub-system and can request data to be retrieved from the memory sub-system.

A memory sub-system can include high density non-volatile memory devices where retention of data is desired when no power is supplied to the memory device. One example of non-volatile memory devices is a not-and (NAND) memory device. Other examples of non-volatile memory devices are described below in conjunction with FIG. 1. A non-volatile memory device is a package of one or more dies. Each die can include of one or more planes. For some types of non-volatile memory devices (e.g., NAND devices), each plane includes of a set of physical blocks. Each block includes of a set of pages. Each page includes of a set of memory cells (“cells”). A cell is an electronic circuit that stores information. Depending on the cell type, a cell can store one or more bits of binary information, and has various logic states that correlate to the number of bits being stored. The logic states can be represented by binary values, such as “0” and “1”, or combinations of such values.

A memory device can include cells arranged in a two-dimensional or a three-dimensional grid. Memory cells can be formed onto a silicon wafer in an array of columns connected by conductive lines (also hereinafter referred to as bitlines, or BLs) and rows connected by conductive lines (also hereinafter referred to as wordlines or WLs). A wordline can refer to a conductive line that connects control gates of a set (e.g., one or more rows) of memory cells of a memory device that are used with one or more bitlines to generate the address of each of the memory cells. In some embodiments, each plane can carry an array of memory cells formed onto a silicon wafer and joined by conductive BLs and WLs, such that a wordline joins multiple memory cells forming a row of the array of memory cells, while a bitline joins multiple memory cells forming a column of the array of memory cells. The intersection of a bitline and wordline constitutes the address of the memory cell. A block hereinafter refers to a unit of the memory device used to store data and can include a group of memory cells, a wordline group, a wordline, or individual memory cells addressable by one or more wordlines. One or more blocks can be grouped together to form separate partitions (e.g., planes) of the memory device in order to allow concurrent operations to take place on each plane. The memory device can include circuitry that performs concurrent memory page accesses of two or more memory planes. For example, the memory device can include a respective access line driver circuit and power circuit for each plane of the memory device to facilitate concurrent access of pages of two or more memory planes, including different page types. For ease of description, these circuits can be generally referred to as independent plane driver circuits. Depending on the storage architecture employed, data can be stored across the memory planes (i.e., in stripes). Accordingly, one request to read a segment of data (e.g., corresponding to one or more data addresses) can result in read operations performed on two or more of the memory planes of the memory device. In some instances, a memory sub-system may experience asynchronous power loss (APL) (e.g., an APL event). Asynchronous power loss refers to when power to a memory sub-system is suddenly lost without warning. Typically, an APL event can cause data loss or corruption of data that has not yet been written to a memory device of the memory sub-system.

Hold-up energy of the memory sub-system is used to allow a memory sub-system to perform (or complete) critical tasks (e.g., single-cell level (SLC) caching) and safely shut down before power is completely lost. Hold-up energy, dependent on the hold-up capacitance, refers to the energy stored in one or more capacitors of the memory sub-system that provide temporary power supply. Hold-up capacitance refers to the amount of capacitance provided by one or more capacitors of the memory sub-system to store hold-up energy to be provided as power to the memory sub-system.

In conventional memory sub-systems, the memory sub-system utilizes hold-up energy to perform SLC write operations during an APL event to mitigate against data loss or corruption before power is completely lost. More specifically, SLC write operations uses SLC mode to write data to a portion of the memory device to store data that has not yet been written using the MLC or TLC mode. SLC write operation is typically faster since the SLC mode is faster than the multi-level cell (MLC) or triple-level cell (TLC) mode. Thus, the amount of hold-up energy required to completely store the data that has not yet been written to the SLC mode is much less than what would be required to attempt to store the data using the MLC or TLC mode. However, the longer it takes to complete SLC write operation during APL, the more hold-up energy required and, thus, the more hold-up capacitance.

Aspects of the present disclosure address the above and other deficiencies by performing SLC write operation in a predetermined number of program pulses without performing intervening program verify operations. In an illustrative example, responsive to detecting an APL event, a memory sub-system controller identifies host data that has not yet been written to a non-volatile memory device (e.g., in-flight host data). Accordingly, the memory sub-system controller performs a program operation with increased programming voltage and/or programming step voltage to write the in-flight host data to memory using SLC. The memory sub-system controller may disable program verify operations to perform only the program operation. Once the in-flight host data is written to the memory using SLC, the memory sub-system controller may properly power down the memory sub-system.

Once the memory sub-system is powered on after the APL event, the memory sub-system controller may read, by a read operation, the in-flight host data from the memory programmed using SLC and store the in-flight host data to another memory using MLC (or TLC). In some embodiments, the memory sub-system controller may increase the pass voltage of the read operation upon powering on of the memory sub-system or after a read error. Pass voltage enables the passage of data from the memory cell to the output line during a read operation. Thus, the read operation after powering on or after a read error may be performed with an adjusted pass voltage.

Advantages of the present disclosure include, but are not limited to, reducing programming time which reduces the amount of hold-up energy required for SLC write operation during an APL event, thereby reducing the amount of capacitors needed in the memory sub-system. As a result, smaller or fewer capacitors may be used in the memory sub-system.

FIG. 1 illustrates an example computing system 100 that includes a memory sub-system 110 in accordance with some embodiments of the present disclosure. The memory sub-system 110 can include media, such as one or more volatile memory devices (e.g., memory device 140), one or more non-volatile memory devices (e.g., memory device 130), or a combination of such.

A memory sub-system 110 can be a storage device, a memory module, or a combination of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to multiple memory sub-systems 110 of different types. FIG. 1 illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller). The host system 120 uses the memory sub-system 110, for example, to write data to the memory sub-system 110 and read data from the memory sub-system 110.

The host system 120 can be coupled to the memory sub-system 110 via a physical host interface. Examples of a physical host interface include, but are not limited to, a serial advanced technology attachment (SATA) interface, a peripheral component interconnect express (PCIe) interface, universal serial bus (USB) interface, Fibre Channel, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), etc. The physical host interface can be used to transmit data between the host system 120 and the memory sub-system 110. The host system 120 can further utilize an NVM Express (NVMe) interface to access components (e.g., memory devices 130) when the memory sub-system 110 is coupled with the host system 120 by the physical host interface (e.g., PCIe bus). The physical host interface can provide an interface for passing control, address, data, and other signals between the memory sub-system 110 and the host system 120. FIG. 1 illustrates a memory sub-system 110 as an example. In general, the host system 120 can access multiple memory sub-systems via a same communication connection, multiple separate communication connections, and/or a combination of communication connections.

The memory devices 130, 140 can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device 130) include a not-and (NAND) type flash memory and write-in-place memory, such as a three-dimensional cross-point (“3D cross-point”) memory device, which is a cross-point array of non-volatile memory cells. A cross-point array of non-volatile memory cells can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 130 can include one or more arrays of memory cells. One type of memory cell, for example, single level cells (SLC) can store one bit per cell. Other types of memory cells, such as multi-level cells (MLCs), triple level cells (TLCs), quad-level cells (QLCs), and penta-level cells (PLCs) can store multiple bits per cell. In some embodiments, each of the memory devices 130 can include one or more arrays of memory cells such as SLCs, MLCs, TLCs, QLCs, PLCs or any combination of such. In some embodiments, a particular memory device can include an SLC portion, and an MLC portion, a TLC portion, a QLC portion, or a PLC portion of memory cells. The memory cells of the memory devices 130 can be grouped as pages that can refer to a logical unit of the memory device used to store data. With some types of memory (e.g., NAND), pages can be grouped to form blocks.

Although non-volatile memory components such as a 3D cross-point array of non-volatile memory cells and NAND type flash memory (e.g., 2D NAND, 3D NAND) are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), not-or (NOR) flash memory, or electrically erasable programmable read-only memory (EEPROM).

A memory sub-system controller 115 (or controller 115 for simplicity) can communicate with the memory devices 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can include a processing device, which includes one or more processors (e.g., processor 117), configured to execute instructions stored in a local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, etc. The local memory 119 can also include read-only memory (ROM) for storing micro-code. While the example memory sub-system 110 in FIG. 1 has been illustrated as including the memory sub-system controller 115, in another embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory devices 130. The memory sub-system controller 115 can be responsible for other operations such as wear leveling operations, garbage collection operations, error detection and error-correcting code (ECC) operations, encryption operations, caching operations, and address translations between a logical address (e.g., a logical block address (LBA), namespace) and a physical address (e.g., physical block address) that are associated with the memory devices 130. The memory sub-system controller 115 can further include host interface circuitry to communicate with the host system 120 via the physical host interface. The host interface circuitry can convert the commands received from the host system into command instructions to access the memory devices 130 as well as convert responses associated with the memory devices 130 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory devices 130.

In some embodiments, the memory devices 130 include local media controllers 135 that operate in conjunction with memory sub-system controller 115 to execute operations on one or more memory cells of the memory devices 130. An external controller (e.g., memory sub-system controller 115) can externally manage the memory device 130 (e.g., perform media management operations on the memory device 130). In some embodiments, memory sub-system 110 is a managed memory device, which is a raw memory device 130 having control logic (e.g., local media controller 135) on the die and a controller (e.g., memory sub-system controller 115) for media management within the same memory device package. An example of a managed memory device is a managed NAND (MNAND) device.

The memory sub-system 110 includes an asynchronous power loss (APL) handling component 113 that can reduce a time to programing of in-flight host data during APL handling. In some embodiments, the memory sub-system controller 115 includes at least a portion of the APL handling component 113. In some embodiments, the APL handling component 113 is part of the host system 120, an application, or an operating system. In other embodiments, local media controller 135 includes at least a portion of APL handling component 113 and is configured to perform the functionality described herein.

The APL handling component 113 can determine whether the memory sub-system 110 experiences a sudden loss of power (e.g., asynchronous power loss (APL) event). Responsive to determining that the memory sub-system 110 experienced an APL event, the APL handling component 113 determines whether host data received by the host system 120 was not stored in memory device 130 and/or 140 (also referred to as in-flight host data). The APL handling component 113 may identify a portion of memory device 130 and/or 140 to be programmed using SLC mode (e.g., SLC memory).

The APL handling component 113 may program the SLC memory with the in-flight host data using the hold-up energy of the memory sub-system before the memory sub-system is completely powered down. As previously described, the hold-up energy refers to the energy stored in capacitors of the memory sub-system to provide temporary power to the memory sub-system in response to an APL event. The memory sub-system uses the temporary power to allow for critical tasks (e.g., the operations performed by the APL handling component 113).

Prior to programming the in-flight host data to the SLC memory, the APL handling component 113 may disable the program verify phase of the program operation. In some embodiments, a plurality of trimsets are stored in the memory sub-system 110 which may be set to a default value or overridden by the APL handling component 113. Accordingly, the APL handling component 113 may update a trimset of the plurality of trimsets to disable program verify.

During a programming phase of a program operation, selected memory cells can be programmed with the application of a programming voltage to a selected wordline. In some cases, an incremental step pulse programming process can be employed to maintain a tight cell threshold voltage distribution for higher data reliability. In the incremental step pulse programming process, a series of high-amplitude pulses of voltage levels having an increasing magnitude (e.g., each pulse is increased by a predefined pulse step height or programming step size with respect to the previous step) are applied to wordlines to which one or more memory cells of the SLC memory are connected, thus gradually raising the voltage level of the memory cells to above a wordline voltage level corresponding to the program operation (e.g., a desired programming level). The application of the uniformly increasing pulses by a wordline driver of the memory device 130 and/or 140 enables the selected wordline to be ramped up to a wordline voltage level corresponding to the program operation. Similarly, a series of voltage pulses having a uniformly increasing voltage level can be applied to the wordline to ramp the wordline to the corresponding wordline voltage level during other memory access operations (e.g., an erase operation). The series of incrementing voltage programming pulses are applied to the selected wordline to increase a charge level, and thereby a threshold voltage, of each memory cell connected to or associated with that wordline.

In the normal model or operation, after each programming pulse, or after a predefined number of programming pulses, a program verify phase of the program operation (e.g., program verify) may be performed to determine if the threshold voltage of the one or more memory cells of the SLC memory has increased to a desired programming level. For example, the pulses can be incrementally increased in value (e.g., by a programming gate voltage step (i.e., voltage value) such as 0.33V) to increase a charge stored on a charge storage structure corresponding to each pulse. Memory cells of the memory devices 130 and/140 can reach a target programming level voltage for a particular programming level by incrementally storing or increasing amounts of charge corresponding to the programming gate voltage step. However, in the APL handling mode of operation, the program verify phase may be disabled in order to avoid reporting a failed program status. By disabling the program verify phase of the program operation, the APL handling component 113 would skip determining whether the threshold voltage of the one or more memory cells of the SLC memory has increased to the desired programming level, thus turning the program operation into a single-phase program operation which only performs the programming phase of the program operation.

The APL handling component 113 may adjust the programming voltage of the programming phase. In particular, the APL handling component 113 may set the programming voltage to a predetermined programming voltage value. The predetermined programming voltage value may be a value that, when applied as a programming pulse to wordlines to which one or more memory cells of the SLC memory are connected, raises the threshold voltage of the one or more memory cells of the SLC memory to at least the desired programming level.

The APL handling component 113 may further adjust the programming step size of the program operation. In particular, the APL handling component 113 may adjust the programming step size of the programming phase to a predetermined programming step size value. The predetermined programming step size value may be a value that increases the programming voltage by the predetermined programming step size value and applies the adjusted programming voltage to wordlines to which one or more memory cells of the SLC memory are connected (as a subsequent programming pulse) to raise the threshold voltage of the one or more memory cells of the SLC memory to above the desired programming level.

Depending on the embodiment, the APL handling component 113 may identify a predetermined number of programming pulses to program in-flight host data to SLC memory. Based on the predetermined number of programming pulses, the APL handling component 113 may set the predetermined programming voltage value and/or the predetermined programming step size value to program in-flight host data to SLC memory. For example, based on a predetermined number of programming pulses set to 1, the APL handling component 113 may set the predetermined programming voltage value extremely high to program in-flight host data to SLC memory in a single programming pulse and match the predetermined number of programming pulses. The predetermined programming step size value may not be adjusted and/or disabled. In another example, based on a predetermined number of programming pulses set to more than 1, the APL handling component 113 may not adjust the predetermined programming voltage value but adjust the predetermined programming step size value relatively high to adjust the number of programming pulses to the predetermined number of programming pulses.

Once the predetermined programming voltage value and/or the predetermined programming step size value has been adjusted, the APL handling component 113 may program (or write) the in-flight host data to the SLC memory using the program operation with the adjusted voltage values (e.g., the predetermined programming voltage value and/or the predetermined programming step size value). Programming the in-flight host data to the SLC memory using the program operation with the adjusted voltage values may reduce the time to program for the in-flight host data. Reduction of the time to program for the in-flight host data reduces the amount of hold-up energy used to perform the APL handling component 113 operations.

Once all in-flight host data is written to SLC memory, the memory sub-system 110 may be powered off. After powering on the memory sub-system, the APL handling component 113 may determine that the memory sub-system 110 is powering up after an APL event. Responsive to powering up after the APL event, the APL handling component 113 reads in-flight host data from the SLC memory and programs the in-flight host data to the other portions of the memory device 130 and/140 using MLC or TLC.

In some embodiments, due to the adjusted voltage values used to program the in-flight host data, the memory cells of the SLC memory may experience pinch off (or pinching). Pinch off (or pinching) refers to a condition where the programmed threshold voltage of a memory cell is higher than the pass voltage used to turn the string on during a read operation thereby failing to turn on the string (conduct current) during a read. To compensate for the pinching of the memory cells associated with the SLC memory, the APL handling component 113 increases a pass voltage during a read operation. The pass voltage enables the passage of data from the memory cell to the output line during a read operation. During a read operation, the pass voltage is applied to all non-selected wordlines during the read operation to turn the rest of the string on, allowing the local media controller 135 to determine the voltage threshold state of the target WL for the read operation (target WL is either above or below the read voltage applied to the WL of the target WL). Accordingly, by increasing the pass voltage, the APL handling component 113 may enable the passage of data from the memory cell to the output line during the read operation.

Depending on the embodiment, the APL handling component 113 may increase the pass voltage on the power on of the memory sub-system after an APL event to anticipate pinching of the memory cells of the SLC memory. Depending on the embodiment, the APL handling component 113 may increase the pass voltage after a read error has occurred in response to reading the memory cells of the SLC memory in the event that the read error may be a result of the pinching of the memory cells.

Depending on the embodiment, the memory sub-system 110 may include a static SLC trimset and a dynamic SLC trimset. In static SLC trimset portions of the memory device always P/E (program/erase) cycled in SLC mode, while in dynamic SLC trimset portions of the memory device may be cycled in either SLC or TLC mode on any given P/E cycle. Typically, dynamic SLC trimset is not utilized in enterprise memory sub-systems, accordingly, the dynamic SLC trimset may be used to implement the operations of APL handling component 113 within enterprise memory sub-systems. Further details with regards to the operations of the APL handling component 113 are described below.

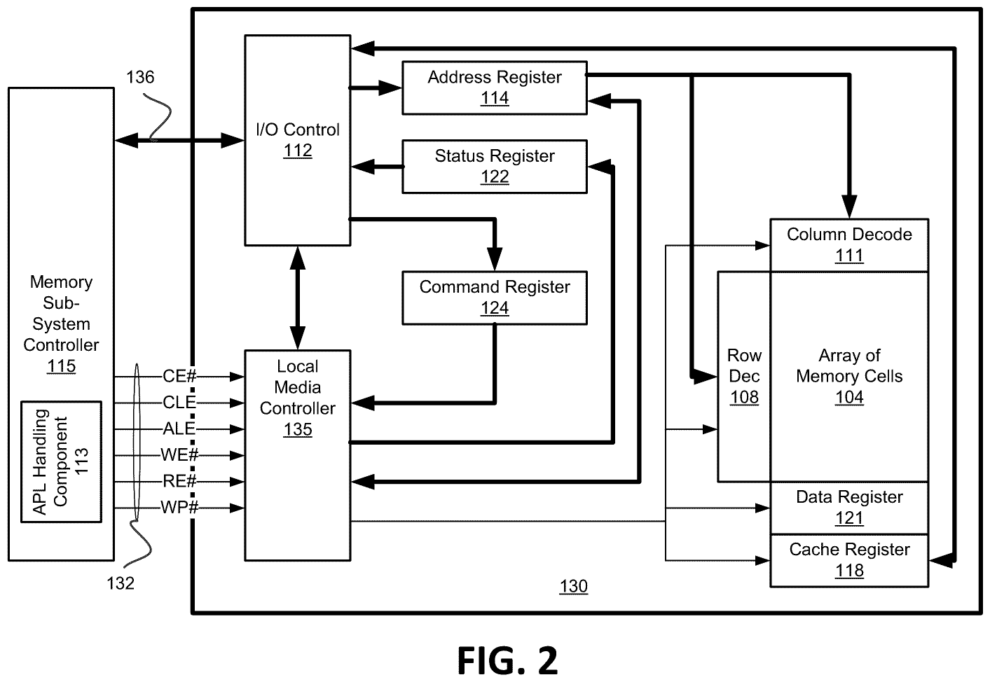

FIG. 2 is a simplified block diagram of a first apparatus, in the form of a memory device 130, in communication with a second apparatus, in the form of a memory sub-system controller 115 of a memory sub-system (e.g., memory sub-system 110 of FIG. 1), according to an embodiment. Some examples of electronic systems include personal computers, personal digital assistants (PDAs), digital cameras, digital media players, digital recorders, games, appliances, vehicles, wireless devices, mobile telephones and the like. The memory sub-system controller 115 (e.g., a controller external to the memory device 130), may be a memory controller or other external host device. In one embodiment, memory sub-system controller 115 includes APL handling component 113, which can implement asynchronous power loss handling with a reduced time to program with respect to memory sub-system, as described herein.

Memory device 130 includes an array of memory cells 104 logically arranged in rows and columns. Memory cells of a logical row are typically connected to the same access line (e.g., a wordline) while memory cells of a logical column are typically selectively connected to the same data line (e.g., a bitline). A single access line may be associated with more than one logical row of memory cells and a single data line may be associated with more than one logical column. Memory cells (not shown in FIG. 2) of at least a portion of array of memory cells 104 are capable of being programmed to one of at least two target data states.

Row decode circuitry 108 and column decode circuitry 111 are provided to decode address signals. Address signals are received and decoded to access the array of memory cells 204. Memory device 130 also includes input/output (I/O) control circuitry 112 to manage input of commands, addresses and data to the memory device 130 as well as output of data and status information from the memory device 130. An address register 114 is in communication with I/O control circuitry 112 and row decode circuitry 108 and column decode circuitry 111 to latch the address signals prior to decoding. A command register 124 is in communication with I/O control circuitry 112 and local media controller 135 to latch incoming commands.

A controller (e.g., the local media controller 135 internal to the memory device 130) controls access to the array of memory cells 104 in response to the commands and generates status information for the external memory sub-system controller 115, i.e., the local media controller 135 is configured to perform access operations (e.g., read operations, programming operations and/or erase operations) on the array of memory cells 204. The local media controller 135 is in communication with row decode circuitry 108 and column decode circuitry 111 to control the row decode circuitry 108 and column decode circuitry 111 in response to the addresses.

The local media controller 135 is also in communication with a cache register 218. Cache register 118 latches data, either incoming or outgoing, as directed by the local media controller 135 to temporarily store data while the array of memory cells 104 is busy writing or reading, respectively, other data. During a programming operation (e.g., a write operation), data may be passed from the cache register 118 to the data register 121 for transfer to the array of memory cells 204; then new data may be latched in the cache register 118 from the I/O control circuitry 212. During a read operation, data may be passed from the cache register 118 to the I/O control circuitry 112 for output to the memory sub-system controller 115; then new data may be passed from the data register 121 to the cache register 218. The cache register 118 and/or the data register 121 may form (e.g., may form a portion of) a page buffer of the memory device 130. A page buffer may further include sensing devices (not shown in FIG. 2) to sense a data state of a memory cell of the array of memory cells 204, e.g., by sensing a state of a data line connected to that memory cell. A status register 122 may be in communication with I/O control circuitry 112 and the local memory controller 135 to latch the status information for output to the memory sub-system controller 115.

Memory device 130 receives control signals at the memory sub-system controller 115 from the local media controller 135 over a control link 132. For example, the control signals can include a chip enable signal CE#, a command latch enable signal CLE, an address latch enable signal ALE, a write enable signal WE#, a read enable signal RE#, and a write protect signal WP#.

Additional or alternative control signals (not shown) may be further received over control link 132 depending upon the nature of the memory device 130. In one embodiment, memory device 130 receives command signals (which represent commands), address signals (which represent addresses), and data signals (which represent data) from the memory sub-system controller 115 over a multiplexed input/output (I/O) bus 136 and outputs data to the memory sub-system controller 115 over I/O bus 136.

For example, the commands may be received over input/output (I/O) pins [7:0] of I/O bus 136 at I/O control circuitry 112 and may then be written into command register 224. The addresses may be received over input/output (I/O) pins [7:0] of I/O bus 136 at I/O control circuitry 112 and may then be written into address register 214. The data may be received over input/output (I/O) pins [7:0] for an 8-bit device or input/output (I/O) pins [15:0] for a 16-bit device at I/O control circuitry 112 and then may be written into cache register 218. The data may be subsequently written into data register 121 for programming the array of memory cells 204.

In an embodiment, cache register 118 may be omitted, and the data may be written directly into data register 220. Data may also be output over input/output (I/O) pins [7:0] for an 8-bit device or input/output (I/O) pins [15:0] for a 16-bit device. Although reference may be made to I/O pins, they may include any conductive node providing for electrical connection to the memory device 130 by an external device (e.g., the memory sub-system controller 115), such as conductive pads or conductive bumps as are commonly used.

In some implementations, additional circuitry and signals can be provided, and that the memory device 130 of FIG. 2 has been simplified. It should be recognized that the functionality of the various block components described with reference to FIG. 2 may not necessarily be segregated to distinct components or component portions of an integrated circuit device. For example, a single component or component portion of an integrated circuit device could be adapted to perform the functionality of more than one block component of FIG. 2. Alternatively, one or more components or component portions of an integrated circuit device could be combined to perform the functionality of a single block component of FIG. 2. Additionally, while specific I/O pins are described in accordance with popular conventions for receipt and output of the various signals, it is noted that other combinations or numbers of I/O pins (or other I/O node structures) may be used in the various embodiments.

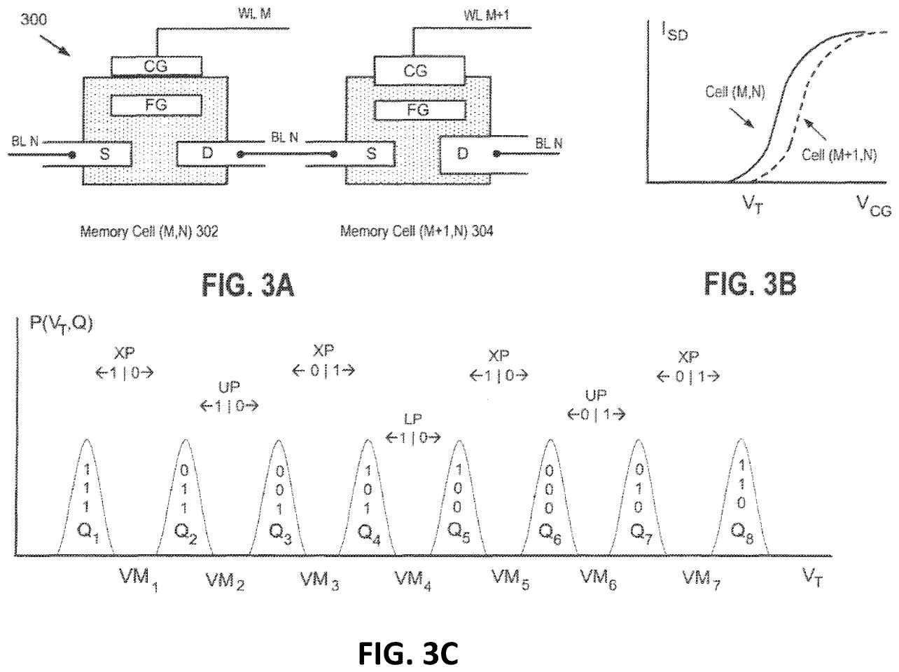

One or more memory devices of the memory sub-system 100 can be represented, e.g., by NAND memory devices that utilize transistor arrays built on semiconductor chips. As illustrated schematically in FIG. 3A, a memory cell of a memory device can be a transistor, such as metal-oxide-semiconductor field effect transistor (MOSFET), having a source(S) electrode and a drain (D) electrode to pass electric current there through. The source and drain electrodes can be connected to a conductive bitline (BL), which can be shared by multiple memory cells. A memory device can include an array or memory cells that are connected to a plurality of wordlines (WL) and a plurality of bitlines (BL). A memory device can further include circuitry for selectively coupling WLs and BLs to voltage sources providing control gate and source-drain signals.

Referring again to FIG. 3A, memory cells 302 and 304 can be connected to the same bitline N and two different conductive wordlines, M and M+1, respectively. A memory cell can further have a control gate (CG) electrode to receive a voltage signal V_{CG} to control the magnitude of electric current flowing between the source electrode and the drain electrode. More specifically, there can be a threshold control gate voltage V_{T} (herein also referred to as “threshold voltage” or simply as “threshold”) such that for V_{CG}<V_{T}, the source-drain electric current can be low, but can increase substantially once the control gate voltage has exceeded the threshold voltage, V_{CG}>V_{T}. Transistors of the same memory device can be characterized by a distribution of their threshold voltages, P(V_{T})=dW/dV_{T}, so that dW=P(V_{T})dV_{T} represents the probability that any given transistor has its threshold voltage within the interval [V_{T}, V_{T}+dV_{T}]. For example, FIG. 3B illustrates schematically dependence of the source-drain current I_{SD} on the control gate voltage for two memory cells, e.g., memory cell 302 (solid line) and memory cell 304 (dashed line), having different threshold control gate voltages.

To make a memory cell non-volatile, the cell can be further equipped with a conducting island-a charge storage node-that can be electrically isolated from the control gate, the source electrode, and the drain electrode by insulating layers (depicted in FIG. 3A as the dotted region). In response to an appropriately chosen positive (in relation to the source potential) control gate voltage V_{CG}, the charge storage node can receive an electric charge Q, which can be permanently stored thereon even after the power to the memory cell—and, consequently, the source-drain current—is ceased. The charge Q can affect the distribution of threshold voltages P(V_{T},Q). Generally, the presence of the electric charge Q shifts the distribution of threshold voltages towards higher voltages, compared with the distribution P(V_{T}) for an uncharged charge storage node. This happens because a stronger positive control gate voltage V_{CG} can be needed to overcome a negative potential of the charge storage node charge Q. If any charge of a sequence Qₖ of charges with 1≤k≤2^{N} can be selectively programmed (and later detected during a read operation) into a memory cell, the memory cell can function as an N-bit storage unit. The charges Qₖ are preferably selected to be sufficiently different from each other, so that any two adjacent voltage distributions P(V_{T}, Qₖ) and P(V_{T}, Qₖ₊₁) do not overlap being separated by a valley margin, so that 2^{N} distributions P(V_{T}, Qₖ) are interspaced with 2^{N}−1 valley margins.

FIG. 3C illustrates schematically a distribution of threshold control gate voltages for a memory cell capable of storing three bits of data by programming the memory cell into at least eight charge states (also referred to as “programming levels”) that differ by the amount of charge on the cell's charge storage node. FIG. 3C shows distributions of threshold voltages P(V_{T}, Qₖ) for 2^{N}=8 different charge states of a tri-level cell (TLC) separated with 2³−1=7 valley margins VMₖ. Accordingly, a memory cell programmed into a charge state k-th (i.e., having the charge Qₖ deposited on its charge storage node) can be storing a particular combination of N bits (e.g., 0110, for N=4). This charge state Qₖ can be determined during a readout operation by detecting that a control gate voltage V_{CG} within the valley margin VMₖ is sufficient to open the cell to the source-drain current whereas a control gate voltage within the preceding valley margin VMₖ₋₁ is not.

Memory devices can be classified by the number of bits stored by each cell of the memory. For example, a single-level cell (SLC) memory has cells that can each store one bit of data (N=1). A multi-level cell (MLC) memory has cells that can each store up to two bits of data (N=2), a tri-level cell (TLC) memory has cells that can each store up to three bits of data (N=3), and a quad-level cell (QLC) memory has cells that can each store up to four bits of data (N=4). In general, the operations described herein can be applied to memory devices having N-bit memory cells, where N>1.

For example, a TLC can be capable of being in one of eight charging states Qₖ (where the first state is an uncharged state Q₁=0) whose threshold voltage distributions are separated by valley margins VMₖ that can be used to read out the data stored in the memory cells. For example, if it is determined during a read operation that a read threshold voltage falls within a particular valley margin of 2^{N}−1 valley margins, it can then be determined that the memory cell is in a particular charge state out of 2^{N} possible charge states. By identifying the right valley margin of the cell, it can be determined what values all of its N bits have. The identifiers of valley margins (such as their coordinates, e.g., location of centers and widths) can be stored in a read level threshold register of the memory controller 215.

As noted herein above, the memory controller 215 can program a state of the memory cell and then read can read this state by comparing a read threshold voltage V_{T} of the memory cell against one or more read level thresholds. The read operation can be performed after a memory cell is placed in one of its charged states by a previous programming operation, which can include one or more programming passes. Each programming pass would apply appropriate programming voltages to a given wordline in order place appropriate charges on the charge storage nodes of the memory cells that are connected to the wordline.

A programming operation involves a sequence of programming voltage pulses that are applied to a selected wordline. Referring again to FIG. 3A, the source (S) and drain (D) electrodes of a memory cell can be connected to a conductive bitline shared by multiple memory cells. A programming operation would apply a sequence of programming voltage pulses to the control gate (CG) via a corresponding wordline (WL). Each programming voltage pulse would induce an electric field that would pull the electrons onto the charge storage node. After each programming pulse is applied to the selected wordline, a verify operation can be performed by reading the memory cell in order to determine whether the threshold voltage V_{T} of the memory cell has reached a desired value (voltage verify level). If the threshold voltage V_{T} of the memory cell has reached the verify voltage associated with the desired state, the bitline to which the memory cell is connected can be biased at the program inhibit voltage, thus inhibiting the memory cells that are coupled to the bitline from being further programmed, i.e., to prevent the threshold voltage V_{T} of the memory cells from shifting further upward in response to subsequent programming pulses applied to the selected wordline.

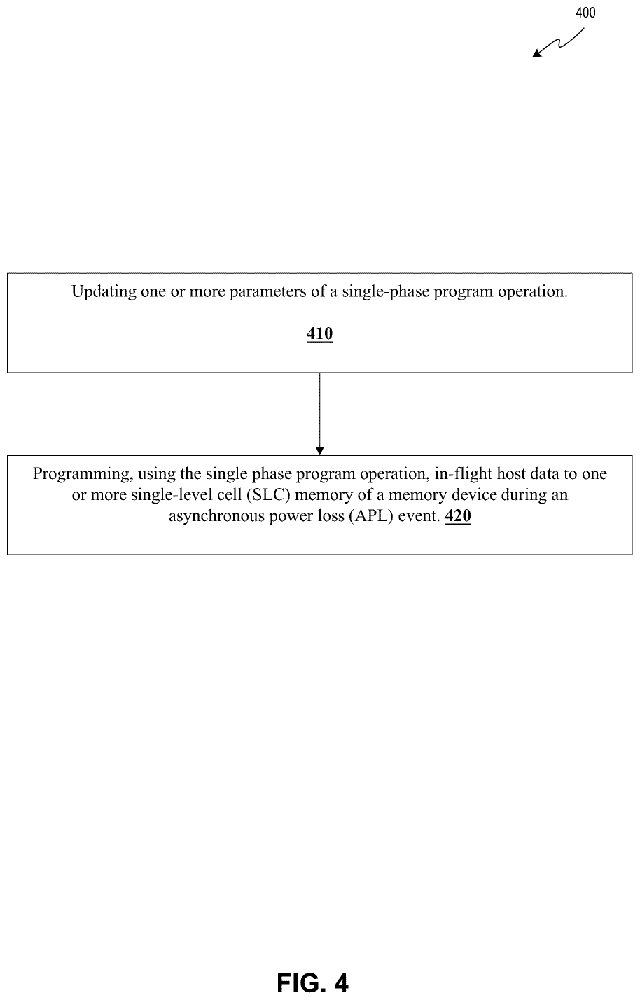

FIG. 4 is a flow diagram of an example method 400 for reducing time to program during asynchronous power loss handling for a memory sub-system, in accordance with some embodiments of the present disclosure. The method 400 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 400 is performed by the APL handling component 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 410, the processing logic updates one or more parameters of a single-phase program operation. At 420, the processing logic programs, using the single phase program operation, in-flight host data to one or more single-level cell (SLC) memory of a memory device during an asynchronous power loss (APL) event. In some embodiments, responsive to determining that one or more parameters of a single-phase program operation has been updated, the processing logic programs, using the single phase program operation, in-flight host data to one or more single-level cell (SLC) memory of a memory device during an asynchronous power loss (APL) event. As previously described, the APL event may be a sudden loss of power to the memory sub-system. In-flight host data may be host data (e.g., received from the host system) not yet written to the memory device due to the APL event.

As previously described, the single-phase program operation refers to a program operation in which a program verify phase of the program operation is disabled. The one or more parameters of the single-phase program operation include at least one of a program start voltage (e.g., a programming voltage) or program step size. As previously described, the programming phase of the program operation (e.g., the only phase of the program operation not disabled), applies a programming voltage to a selected wordline to raise the voltage level of the memory cells to be programmed to a desired programming level. Subsequent programming pulses may be used to apply to the selected wordline to raise the voltage level of the memory cells to be programmed to a desired programming level. Each programming pulse involves increasing the programming voltage by the program step size prior to application of the programming pulse to the selected wordline.

As previously described, the programming voltage of the one or more parameters of the single-phase program operation may be adjusted so that the in-flight host data may be programmed in a single programming pulse. In some embodiments, the one or more parameters of the single-phase program operation may be updated based on a predetermined number of programming pulses to be used to program in-flight host data to the one or more SLC memory.

In some embodiments, the processing logic programs, using the single phase program operation, in-flight host data may include determining whether a read voltage associated with cells of each of the one or more SLC memory exceeds a target read voltage value (e.g., a desired programming level).

In an embodiment, once all in-flight host data is written to SLC memory, the processing logic performs a read operation on the one or more SLC memory to read the in-flight host data responsive to powering on the memory device. Once the in-flight host data is read from the one or more SLC memory, the processing logic programs the in-flight host data to one or more multi-level cells of the memory device. Depending on the embodiment, as previously described, to anticipate read errors caused by pinching of the memory cells of the one or more SLC memory, the processing logic adjusts (e.g., increases) a pass voltage of the read operation to a predetermined value.

In another embodiment, once all in-flight host data is written to SLC memory and responsive to detecting a read operation failure on the one or more SLC memory to read the in-flight host data, the processing logic adjusts (e.g., increases) a pass voltage of a subsequent read operation. Once adjusted, the processing logic performs the subsequent read operation on the one or more SLC memory to read the in-flight host data. Once the in-flight host data is read from the one or more SLC memory, the processing logic programs the in-flight host data to one or more multi-level cells of the memory device.

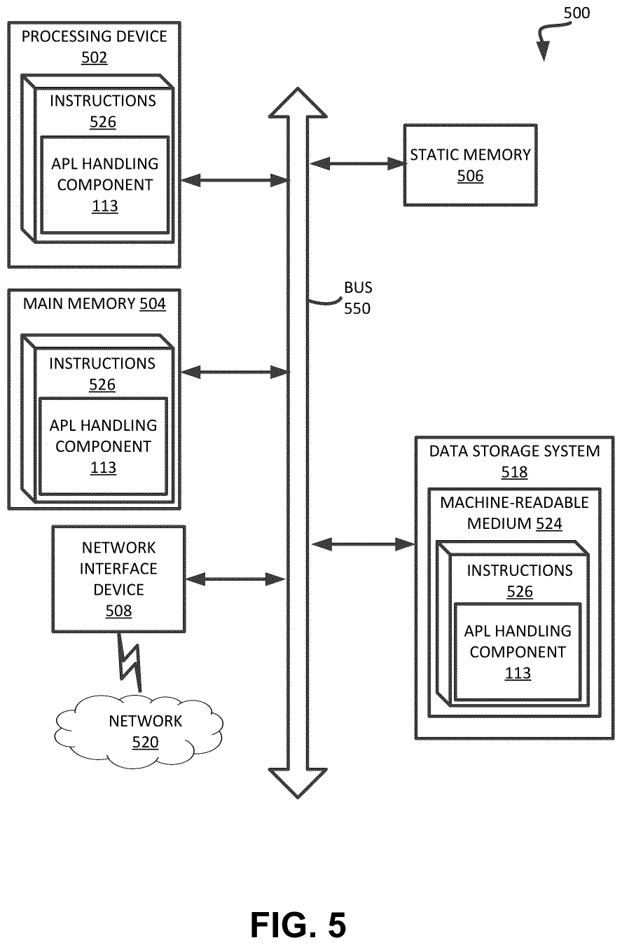

FIG. 5 illustrates an example machine of a computer system 500 within which a set of instructions, for causing the machine to perform any one or more of the methodologies discussed herein, can be executed. In some embodiments, the computer system 500 can correspond to a host system (e.g., the host system 120 of FIG. 1) that includes, is coupled to, or utilizes a memory sub-system (e.g., the memory sub-system 110 of FIG. 1) or can be used to perform the operations of a controller (e.g., to execute an operating system to perform operations corresponding to the APL handling component 113 of FIG. 1). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 300 includes a processing device 502, a main memory 504 (e.g., read-only memory (ROM), flash memory, dynamic random access memory (DRAM) such as synchronous DRAM (SDRAM) or RDRAM, etc.), a static memory 506 (e.g., flash memory, static random access memory (SRAM), etc.), and a data storage system 518, which communicate with each other via a bus 530.

Processing device 502 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 502 can also be one or more special-purpose processing devices such as an application specific integrated circuit (ASIC), a field programmable gate array (FPGA), a digital signal processor (DSP), network processor, or the like. The processing device 502 is configured to execute instructions 526 for performing the operations and steps discussed herein. The computer system 500 can further include a network interface device 508 to communicate over the network 520.

The data storage system 518 can include a machine-readable storage medium 524 (also known as a computer-readable medium) on which is stored one or more sets of instructions 526 or software embodying any one or more of the methodologies or functions described herein. The instructions 526 can also reside, completely or at least partially, within the main memory 504 and/or within the processing device 502 during execution thereof by the computer system 500, the main memory 504 and the processing device 502 also constituting machine-readable storage media. The machine-readable storage medium 524, data storage system 518, and/or main memory 504 can correspond to the memory sub-system 110 of FIG. 1.

In one embodiment, the instructions 526 include instructions to implement functionality corresponding to an APL handling component (e.g., the APL handling component 113 of FIG. 1). While the machine-readable storage medium 524 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method comprising:
responsive to determining that one or more parameters of a single-phase program operation has been updated, programming, using the single phase program operation, in-flight host data to one or more single-level cell (SLC) memory of a memory device during an asynchronous power loss (APL) event.

2. The method of claim 1, wherein programming, using the single phase program operation, in-flight host data comprises determining whether a read voltage associated with cells of each of the one or more SLC memory exceeds a target read voltage value.

3. The method of claim 1, wherein the in-flight host data is host data not yet written to the memory device due to the APL event.

4. The method of claim 1, wherein the one or more parameters of the single-phase program operation include at least one of: a program start voltage or a program step size.

5. The method of claim 1, wherein the one or more parameters of the single-phase program operation are updated based on a predetermined number of programming pulses to be used to program in-flight host data to the one or more SLC memory.

6. The method of claim 1, further comprising:
responsive to powering on the memory device, performing a read operation on the one or more SLC memory to read the in-flight host data; and
programming the in-flight host data from the one or more SLC memory to one or more multi-level cells of the memory device.

7. The method of claim 6, wherein performing the read operation on the one or more SLC memory to read the in-flight host data includes adjusting, prior to the read operation, a pass voltage of the read operation to a predetermined value.

8. The method of claim 1, further comprising:
responsive to detecting a read operation failure on the one or more SLC memory to read the in-flight host data after powering on the memory device, adjusting, prior to a subsequent read operation on the one or more SLC memory, a pass voltage; and
performing, using the adjusted pass voltage, the subsequent read operation on the one or more SLC memory to read the in-flight host data.

9. A system comprising:
one or more memory devices; and
a processing device, operatively coupled to the one or more memory devices, the processing device to perform operations comprising:
responsive to determining that one or more parameters of a single-phase program operation has been updated, programming, using the single phase program operation, in-flight host data to one or more single-level cell (SLC) memory of a memory device during an asynchronous power loss (APL) event.

10. The system of claim 9, wherein programming, using the single phase program operation, in-flight host data comprises determining whether a read voltage associated with cells of each of the one or more SLC memory exceeds a target read voltage value.

11. The system of claim 9, wherein the in-flight host data is host data not yet written to the memory device due to the APL event.

12. The system of claim 9, wherein the one or more parameters of the single-phase program operation include at least one of: a program start voltage or a program step size.

13. The system of claim 9, wherein the one or more parameters of the single-phase program operation are updated based on a predetermined number of programming pulses to be used to program in-flight host data to the one or more SLC memory.

14. The system of claim 9, wherein the processing device is to perform operations further comprising:
responsive to powering on the one or more memory devices, performing a read operation on the one or more SLC memory to read the in-flight host data; and
writing the in-flight host data from the one or more SLC memory to one or more multi-level cells of the memory device.

15. The system of claim 14, wherein performing the read operation on the one or more SLC memory to read the in-flight host data includes adjusting, prior to the read operation, a pass voltage of the read operation to a predetermined value.

16. The system of claim 9, wherein the processing device is to perform operations further comprising:
responsive to detecting a read operation failure on the one or more SLC memory to read the in-flight host data, adjusting, prior to a subsequent read operation on the one or more SLC memory, a pass voltage; and
performing, using the adjusted pass voltage, the subsequent read operation on the one or more SLC memory to read the in-flight host data.

17. A non-transitory computer-readable storage medium comprising instructions that, when executed by a processing device, cause the processing device to perform operations comprising:
responsive to determining that one or more parameters of a single-phase program operation has been updated, programming, using the single phase program operation, in-flight host data to one or more single-level cell (SLC) memory of a memory device during an asynchronous power loss (APL) event.

18. The non-transitory computer-readable storage medium of claim 17, wherein the one or more parameters of the single-phase program operation are updated based on a predetermined number of programming pulses to be used to program in-flight host data to the one or more SLC memory.

19. The non-transitory computer-readable storage medium of claim 17, wherein the processing device is to perform operations further comprising:
responsive to powering on the memory device, adjusting a pass voltage of a read operation to a predetermined value;
performing the read operation on the one or more SLC memory to read the in-flight host data; and
writing the in-flight host data from the one or more SLC memory to one or more multi-level cells of the memory device.

20. The non-transitory computer-readable storage medium of claim 17, wherein the processing device is to perform operations further comprising:
responsive to detecting a read operation failure on the one or more SLC memory to read the in-flight host data after powering on the memory device, adjusting, prior to a subsequent read operation on the one or more SLC memory, a pass voltage; and
performing, using the adjusted pass voltage, the subsequent read operation on the one or more SLC memory to read the in-flight host data.
